(19) United States
(12) Patent Application Publication
(10) Pub. No.: US 2010/0071965 A1
(43) Pub. Date: Mar. 25, 2010

(54) SYSTEM AND METHOD FOR GRAB AND DROP GESTURE RECOGNITION

(75) Inventors: Nan Hu, Stanford, CA (US); David Kryze, Santa Barbara, CA (US); Rabindra Pathak, San Jose, CA (US)

Correspondence Address: GREGORY A. STOBBS, 5445 CORPORATE DRIVE, SUITE 400, TROY, MI, 48098, US

(73) Assignee: PANASONIC CORPORATION, Osaka (JP)

(21) Appl. No.: 12/325,435

(22) Filed: Dec. 1, 2008

Related U.S. Application Data
(60) Provisional application No. 61/099,332, filed on Sep. 23, 2008.

(51) Int. Cl. G06F 3/044; G06F 3/041

(52) U.S. Cl. 178/18.06; 178/18.03

(57) ABSTRACT

X-axis and Y-axis sensor arrays detect hand motion. The array data are processed by a trained model gesture recognizer to discriminate between grab and touch gestures. Touch gestures are further processed using touch point classifier, Hidden Markov Model and peak detector to discriminate between single point touch and multiple point touch. A Kalman tracker analyzes the trajectories of the X and Y axis data to determine how to associate X and Y axis data into ordered pairs corresponding to the touch points. The system resolves ambiguities inherent in certain sensor arrays and will also detect grab and drop gestures where the detected hand is sometimes out of sensor range during the gestural sequence.

### BACKGROUND

As human machine interactions evolve from simple finger touch of a button on the touch sensitive screen of a device to more complex interactions like multi-touch or touchless interactions, user expectations are building up for new experiences that are more complex and real-life. For example, users expect that devices provide interactions for real-life gestures for grabbing an object like a sheet of paper and dropping it in a paper tray, grabbing a photo and passing it to another person etc.

These real-life gestures are much more complex and need innovation on hardware to provide complex detection and tracking and extreme level of processing through software to compose those detections into a synthesized gesture like grab. Currently there is lack of this type of technology.

While multi-touch technologies have been used in some personal digital assistant products, music player products and smart phone products, to detect multiple finger pinch gestures, these rely on comparatively expensive sensor technology that do not cost-effectively scale to larger sizes. Thus there remains a need for gesture recognition systems and methods that can be implemented with low cost sensor arrays suitable for larger sized devices.

### SUMMARY

The present technology provides a cost-effective technology for recognizing complex gestures, like grab and drop performed by human hand. This technology can be scaled to accommodate very large displays and surfaces like large screen TVs or other large control surfaces, where conventional technology used in smaller personal digital assistants, music players or smart phones would be cost prohibitive.

In accordance with one aspect, the disclosed system and method employs an algorithm and computational model for detection and tracking of human hand grabbing an object and dropping an object in a 2-D or 3-D space. In this case user can lift its hand completely off the surface and into the air and then drop it on the surface.

In accordance with another aspect, the disclosed system and method employs an algorithm and computational model for detection and tracking of human hand grabbing an object on surface and then dragging it on the surface from one point to another and then dropping it. In this case hand of the user is constantly in touch with the surface and hand is never lifted completely off the surface.

### BRIEF DESCRIPTION OF THE DRAWINGS

FIG. 1 is a system block diagram of a presently preferred embodiment for grab and drop gesture recognition;

FIG. 2 is a three-dimensional point cloud graph, showing an exemplary distribution for grab and touch discrimination;

FIG. 3 is a graph showing the cross-validation error for different number of features used, separately showing both false negative and false positive errors;

FIG. 4a is a graph showing exemplary capacitance readings of a single touch point, separately showing both X-axis and Y-axis sensor readings;

FIG. 4b is a graph showing exemplary capacitance readings of a two touch points, separately showing both X-axis and Y-axis sensor readings;

FIG. 5a is a three-dimensional point cloud graph, showing exemplary grab and touch distributions of data from the X-axis sensor readings;

FIG. 5b is a three-dimensional point cloud graph, showing exemplary grab and touch distributions of data from the Y-axis sensor readings;

FIG. 6 is a graph showing cross validation error vs. the number of features used, separately showing false negative and false positive for each of the X-axis and Y-axis sensor readings;

FIG. 7 is a diagram illustrating a presently preferred Hidden Markov Model useful in implementing the touch gesture recognition;

FIG. 8 is a hardware block diagram of a presently preferred implementation of the grab and drop gesture recognition system;

FIG. 9 is a graphical depiction of a sensor array using separate X-axis and Y-axis detectors, useful in understanding the source of ambiguity inherent to these types of sensors; and

FIG. 10 is a block diagram of a presently preferred gesture recognizer.

### DETAILED DESCRIPTION

Human machine interactions for consumer electronic devices are gravitating towards more intuitive methods based on touch and gestures and away from the existing mouse and keyboard approach. For many applications touch sensitive surface is used for users to interact with underlying system. Same touch surface can also be used as display for many applications. Consumer electronics displays are getting thinner and less expensive. Hence there is need for a touch surface that is thin and inexpensive and provides multi-touch experience.

The exemplary embodiment illustrated here uses a multi-touch surface based on capacitive sensor arrays that can be packaged in a very thin foil, at a fraction of the cost of sensors typically used for multi-touch solutions. Although inexpensive sensor technology is used, we can still accurately detect and track complex gestures like grab, drag and drop. Thus while the illustrated embodiment uses capacitive sensors as underlying technology to provide touch point detection and tracking, this invention can be easily implemented using other types of sensors, including but not limited to resistive, pressure, optical or magnetic sensors to provide the touch detection and tracking. As long as we are able to determine the touch points, using any available technology, grab and drop gesture can be composed and detected easily using the algorithms disclosed herein.

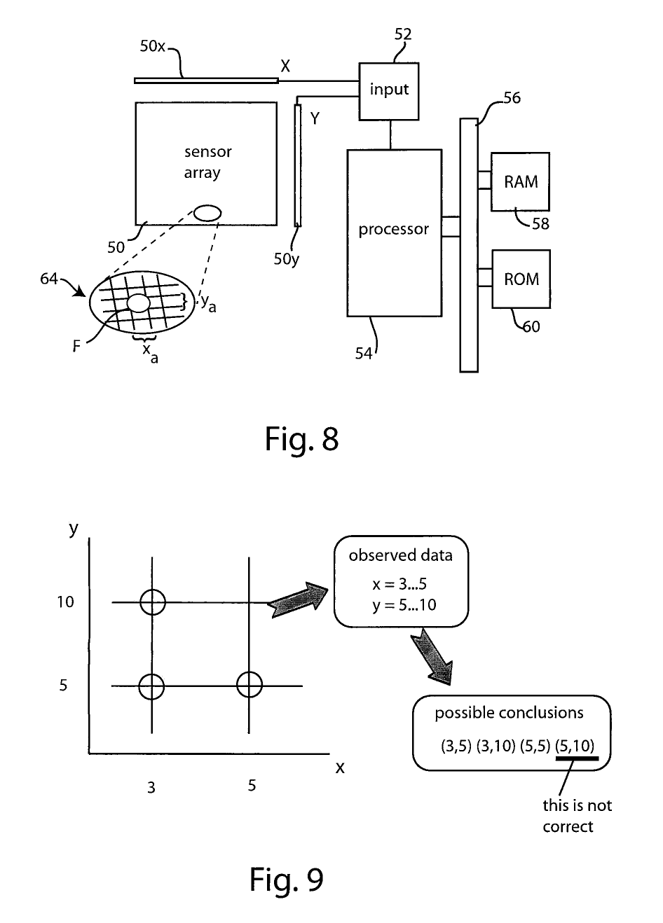

As illustrated in FIG. 8, in a preferred embodiment, an interactive foil is used which has array of capacitive sensors 50 along its two adjacent sides. One array 50x senses X-coordinate and another array 50y senses Y-coordinate of touch points on the surface of the foil. Thus two arrays can provide the location of a touch points like touch of a finger on the foil. This foil can be mounted under one glass surface or sandwiched between two glass surfaces. Alternatively it can be mounted on a display surfaces like TV screen panels. The methods and algorithms disclosed herein operate upon the sensor data to accurately detect and track complex gestures like grab, drag and drop based on the detection of touch points. Touch points are detected in this preferred embodiment using capacitive sensors, however, our technology is not limited to touch point detection using capacitive sensors. Many other types of sensors like resistive sensors or optical sensors (like those used in digital cameras) can be used to detect the touch points and then the algorithms disclosed herein can be applied to recognize the grab and drop gesture.

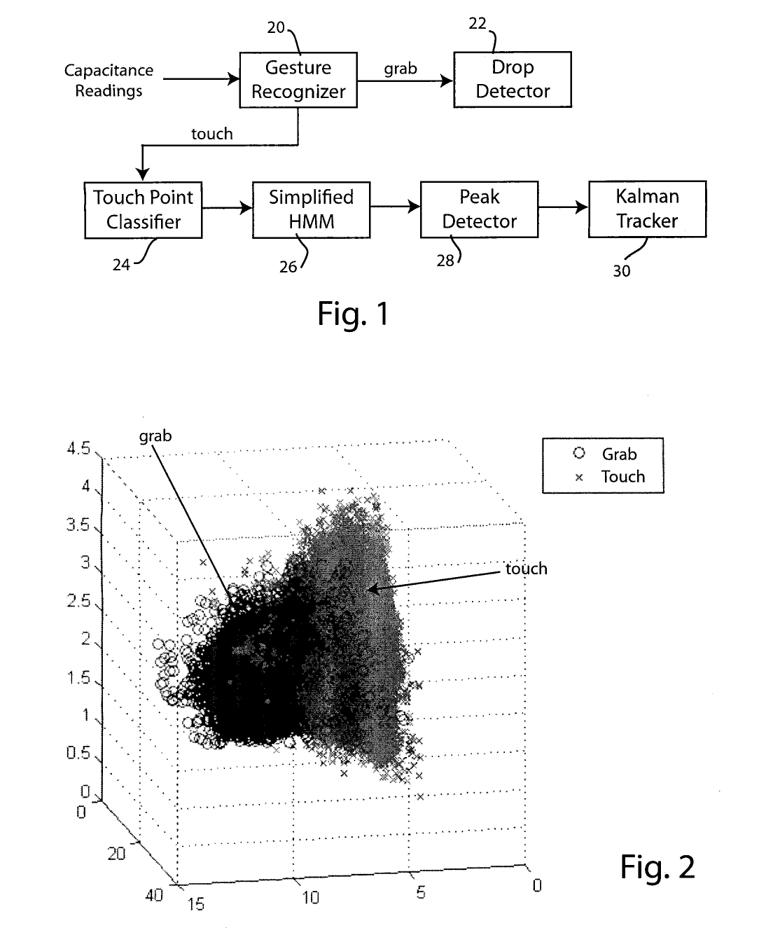

As illustrated in FIG. 8, the sensor array 50 (50x and 50y) is coupled to a suitable input processor or interface by which the capacitance readings developed by the array are input to the processor 54, which may be implemented using a suitably programmed microprocessor. As illustrated the processor communicates via a bus 56 with its associated random access memory (RAM) 58 and with a storage memory that contains the executable program instructions that control the operation of the processor in accordance with the steps illustrated in FIG. 1 and discussed herein. As illustrated here, the program instructions may be stored in read only memory (ROM) 60, or in other forms of non-volatile memory. If desired, the components illustrated in FIG. 8 may also be implemented using one or more application specific integrated circuits (ASICs).

The interactive foil is composed of capacitance sensors on both the vertical and horizontal direction, as shown in the magnified detail at 64. To simplify description, we refer here to the vertical direction as the y-axis and the horizontal direction as the x-axis. The capacitance sensor is sensitive to conductive objects like human body parts when they are near the surface of the foil. The x-axis and the y-axis are, however, independent while reading sensed capacitance values. When the human body parts, e.g. a finger F, comes close enough to the surface, the capacitance values on the corresponding x and y-axis will increase (xₐ, yₐ). It thus makes possible the detection of a single or multiple touch points. In our development sample, the foil is 32 inches long diagonally, and the ratio of the long and short sides is 16:9. Therefore, the corresponding sensor distance in the x-axis is about 22.69 mm and that in the y-axis is about 13.16 mm. Based on these specifications of the hardware, a set of algorithms is developed to detect and track the touch points and gestures like grab and drop, as will be described in the following sections.

It will be appreciated that the capacitance sensor can be implemented upon an optically clear substrate, using extremely fine sensing wires, so that the capacitive sensor array can be deployed over the top of or sandwiched within display screen components. Doing this allows the technology of this preferred embodiment to be used for touch screens, TV screens, graphical work surfaces, and the like. Of course, if see-through capability is not required, the sensor array may be fabricated using an opaque substrate.

When fingers touch or even come near enough to the surface of the sensor array, the capacitances of the nearby sensors will increase. By constantly reading or periodically polling the capacitance values of the sensors, the system can recognize and distinguish among different gestures. Using the process that will next be discussed, the system can distinguish the “touch” gesture from the “grab and drop” gesture. In this regard, the touch gesture involves the semantic of simple selection of a virtual object, by pointing to it with the fingertip (touch). The grab and drop gesture involves the semantic of selecting and moving a virtual object by picking up (grabbing) the object and then placing it (dropping) in another virtual location.

Distinguishing between the touch gesture and the grab and drop gesture is not as simple as it might seem at first blush, particularly with the capacitive sensor array of the illustrated embodiment. This is because the sensor array comprised of two separate X-coordinate and Y-coordinate sensor arrays cannot always discriminate between single touch and multiple touch (there are ambiguities in the sensor data). To illustrate, refer to FIG. 9. In that illustration the user has touched three points simultaneously at x-y coordinates (3,5), (3,10) and (5,5). However, the separate X-coordinate and Y-coordinate sensor arrays simply report sensed points x=3, x=5; y=5, y=10. Unlike true multi-touch sensors, the precise touch points are not detected, but only the X and Y grid lines upon which the touch points fall. Thus, from the observed data there are four possible combinations that satisfy each of the X-Y combinations: (3,5), (3,10), (5,5) and (5,10). We can see that the combination (5,10) does not correspond to any of the actual touch points.

The system and method of the present disclosure is able to distinguish between touch and grab and drop gestures, even despite these inherent shortcomings of the separate X-coordinate and Y-coordinate sensor arrays. It does this using trained model-based pattern recognition and trajectory recognition algorithms. By way of overview, when a touch is recognized, touch points are detected and every detected touch point is tracked individually when they move. The algorithm deems grab and drop as a recognized gesture, and therefore when a grab is recognized it waits until a drop (another recognized gesture) is found or timeout occurs. User can also drag the grabbed object before dropping it.

The grab and drop algorithms and procedures address the ambiguity problem associated with capacitive sensors by using pattern recognition to infer where the touch points are (and thereby resolve the ambiguity). At any given instant, the inference may be incorrect; but over a short period of time, confidence in the inference drawn from the aggregate will grow to a degree where it can reasonably be relied upon. Another important advantage of such pattern recognition is that the system can infer gestural movements even when the data stream from the sensor array has momentarily ceased (because the user has lifted his hand far enough from the sensor array that it is no longer being capacitively sensed). When the user's hand again moves within sensor range, the recognition algorithm is able to infer whether the newly detected motion is part of the previously detected grab and drop operation by relying on the trained models. In other words, groups of sensor data that closely enough match the grab and drop trained models will be classified as a grab and drop operation, even though the data has dropouts or gaps caused by the user's hand being out of sensor range.

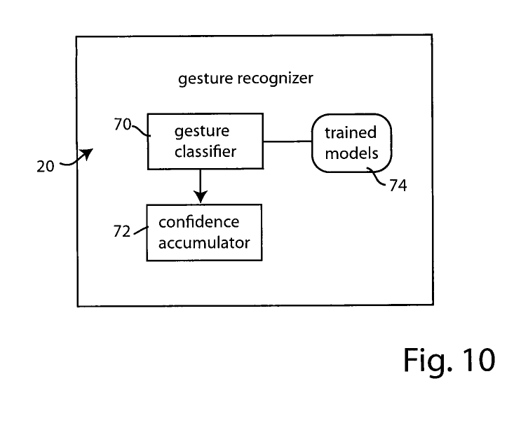

A data flow diagram of the basic process is shown in FIG. 1. An overview of the entire process will be presented first. Details of each of the functional blocks are then presented further below. Capacitance readings from the sensor arrays (e.g., see FIG. 10) are first passed to the gesture recognizer 20. The gesture recognizer is trained offline to discriminate between a grab gesture and a touch gesture. If the detected gesture is recognized as a grab gesture, the drop detector 22 is invoked. The drop detector basically analyzes the sensor data, looking for evidence that the user has “dropped” the grabbed virtual object.

If the detected gesture is recognized as a touch gesture, then further processing steps are performed. The data are first analyzed by the touch point classifier 24, which performs the initial assessment whether the touch corresponds to a single touch point, or a plurality of touch points. The classifier 24 uses models that are trained off-line to distinguish between single and multiple touch points.

Next the classification results are fed into a simplified Hidden Markov Model (HMM) 26 to update the posteriori probability. The HMM probabilistically smoothes the data over time. Once the posteriori reaches the threshold, the corresponding number of touch points is confirmed and the peak detector 28 is applied to the readings to find the local maxima. The peak detector 28 analyzes the confirmed number of touch points to pinpoint more precisely where the touch point occurred. For a single touch point, the global maximum is detected; for multiple touch points, a set of local maxima are detected.

Finally, a Kalman tracker 30 associates the respective touch points from the X-axis and Y-axis sensors as ordered pairs. The Kalman filter is based on a constant speed model that is able to associate touch points at different time frames, as well as provide data smoothing as the detected points move during the gesture. The Kalman tracker 30 may only need to be optionally invoked. It is invoked if plural touch points have been detected. In such case the Kalman tracker 30 resolves the ambiguity that arises when two points touch the sensor at the same time. If only one touch point was detected, it is not necessary to invoke the Kalman tracker.

### Gesture Recognizer

The gesture recognizer 20 is preferably designed to recognize two categories of gestures, i.e. grab-and-drop and touch, and it is composed of two modules, a gesture classifier 70, and a confidence accumulator 72. See FIG. 10.

To recognize the gesture of grab-and-drop and touch, sample data are collected for offline training. The samples are collected by having a population of different people (representing different hand sizes and both left-handed and right-handed) make repeated grab and drop gestures while recording the sensor data throughout the grab and drop sequence. The sample data are then stored as trained models 74 that the gesture classifier 70 uses to analyze new, incoming sensor data during system use. Notice that the grab-and-drop gesture is characterized by a grab and followed by a drop; the correct recognition of the grab is the critical part for this gesture. Hence, in the data collection, we focus on the grab data. Because the grab gesture precedes the drop gesture, we can analyze the collected capacitive readings of the training data and appropriately label the grab and drop regions within the data. With this focus, a reasonable feature set can be represented by the statistics of the capacitive readings.

To visualize the distribution of the two gestures, a point cloud is shown in FIG. 2. For demonstration purpose, we show the points using the first three normalized central moments. The classifier used to recognize gestures is based on mathematical formulas, which are discussed in detail below. See discussion of touch point classifier. Although the other parts of the system would be kept as the same when working with different kinds of the sensors, the classifier may need to be modified, either to change the parameters or the model itself, to accommodate the sensors being used.

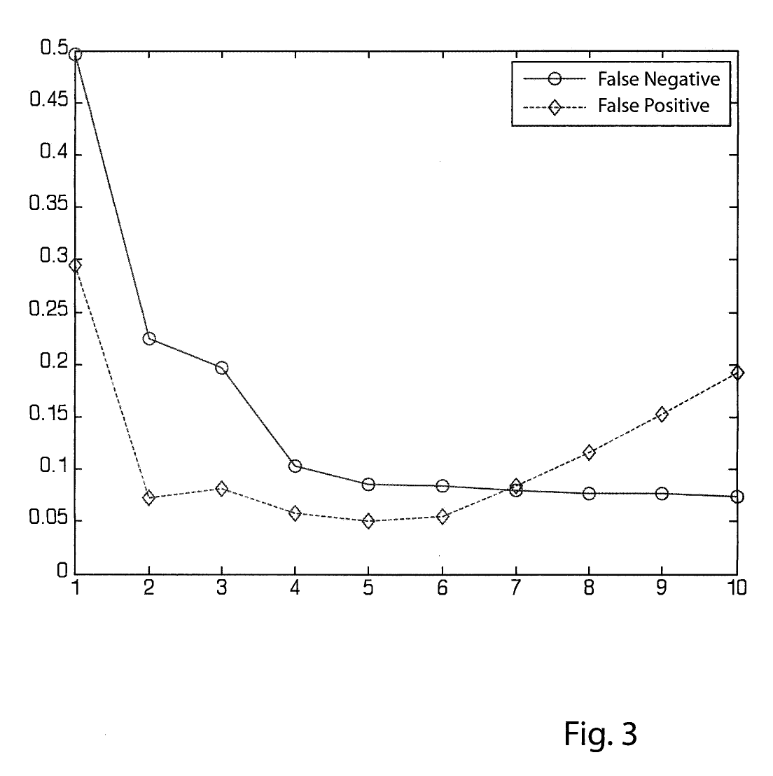

To select the number of normalized central moments used in the recognizer, we employ a k-fold cross-validation technique to estimate the classification error for different selection of the features as shown in FIG. 3. As can be seen, a good choice for the number of features could be four or five features, and in our exemplary implementation, we used four features: the mean, standard deviation, and the normalized third and fourth central moments.

The estimate of the false positive and false negative rates as shown in FIG. 3 are around 10%. In a system where such a 10% classification error would be deemed undesirable, a confidence accumulation technique can be used. In the illustrated embodiment, we use a Bayesian confidence accumulation scheme to improve classification performance. The Bayesian confidence accumulator 72 is shown in FIG. 10. The confidence accumulator is based upon and performs the following analysis.

Let Sₙ be the gesture when the n-th readings are collected, and Wₙ be the classification results of the n-th reading. The performance of the classifier was modeled as P(Wₙ|Sₙ), which were estimated by k-fold cross validation during training. From Sₙ₋₁ to Sₙ, there is a probability of transition P(Sₙ|Sₙ₋₁). Suppose as time n−1, we have the posteriori probability of P(Sₙ₋₁|Wₙ₋₁, . . . , W₀), after the classifier processed n-th readings, the new posteriori probability P(Sₙ|Wₙ, . . . , W₀) will then be updated as

$$\begin{matrix}P ( {S}_{n} \vert {W}_{n} , … , {W}_{0} ) = \frac{P ( {S}_{n} , {W}_{n} \vert {W}_{n - 1} , … , {W}_{0} )}{P ( {W}_{n} \vert {W}_{n - 1} , … , {W}_{0} )} \\ = \frac{{\sum }_{{S}_{n - 1}} P ( {S}_{n} , {W}_{n} , {S}_{n - 1} \vert {W}_{n - 1} , … , {W}_{0} )}{{\sum }_{{S}_{n}} {\sum }_{{S}_{n - 1}} P ( {S}_{n} , {W}_{n} , {S}_{n - 1} \vert {W}_{n - 1} , … , {W}_{0} )} \\ = \frac{\begin{matrix}{\sum }_{{S}_{n - 1}} P ( {W}_{n} \vert {S}_{n} ) P ( {S}_{n} \vert {S}_{n - 1} ) \\ P ( {S}_{n - 1} \vert {W}_{n - 1} , … , {W}_{0} )\end{matrix}}{\begin{matrix}{\sum }_{{S}_{n}} {\sum }_{{S}_{n - 1}} P ( {W}_{n} \vert {S}_{n} ) P ( {S}_{n} \vert {S}_{n - 1} ) \\ P ( {S}_{n - 1} \vert {W}_{n - 1} , … , {W}_{0} )\end{matrix}}\end{matrix}$$

As can be seen, the posteriori probability P(Sₙ|Wₙ, . . . , W₀) accumulates when Wₙ's are collected. Once it is high enough, we confirm the corresponding gesture and the system goes to the follow-up procedures for that gesture.

If the gesture of grab is confirmed, the grab point needs to be estimated. The way the system estimates it is by thresholding and weighted averaging, which is discussed more fully below in connection with estimation of the drop point.

### Drop Detector

When a grab gesture is confirmed, the system waits until there is no contact with the sensor array to initialize the drop detector 22. The drop detector initialized like this is then very simple to implement. We simply need to detect the next time when any human body parts contact the touch screen and this is done by a threshold c₀ on the average capacitive readings.

To estimate the position of the grab point and the drop point, a threshold-and-averaging method is employed. The idea is to first find a threshold and then average the position of the readings that are over the threshold. In this implementation, the threshold is found by calculating a weighted average of the maximum reading and the average reading. Let cₘₐₓ be the maximum reading and c_{avg} be the average reading, the threshold cₕ is then set to

cₕ=w₀c_{avg}+w₁cₘₐₓ, subject to, w₀+w₁=1,w₀,w₁>0

The position of the grab or drop point can be easily estimated as the average of the position of the points that are over the threshold cₕ. The drop ends when no contact with the touch screen is present, which is again by the threshold c₀. After the drop gesture finished, the system goes back the very beginning.

### Touch Point Classifier

If a touch is confirmed in the gesture recognizer, the capacitive readings are further passed to this touch point classifier. In this section, we will describe the way we make our touch point classifier work. To simplify the discussion let's take a scenario where only up to two touch points can be present on the touch screen. The proposed algorithm, however, can be extended to handle more than two touch points by simply adding classes when training the classifier as well as increasing the states in the simplified Hidden Markov Model as described below. For example, in order to detect and track three points, we need to add three classes in the classifier during training it and increase the states to three in Simplified Hidden Markov Model.

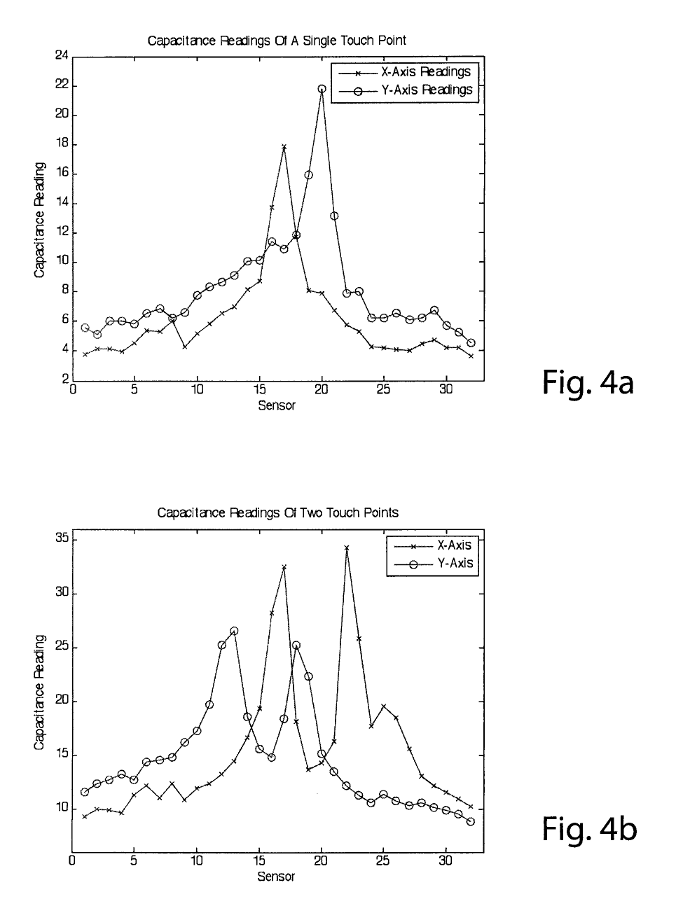

Sample capacitance readings for a single touch point and two touch points are shown in FIG. 4. As the touch point moves, the peak will also move. But notice that the statistics of the reading may be stable even as the position of the peak and the values of the each individual sensor may vary. Features are then selected as the statistics of the readings on each axis.

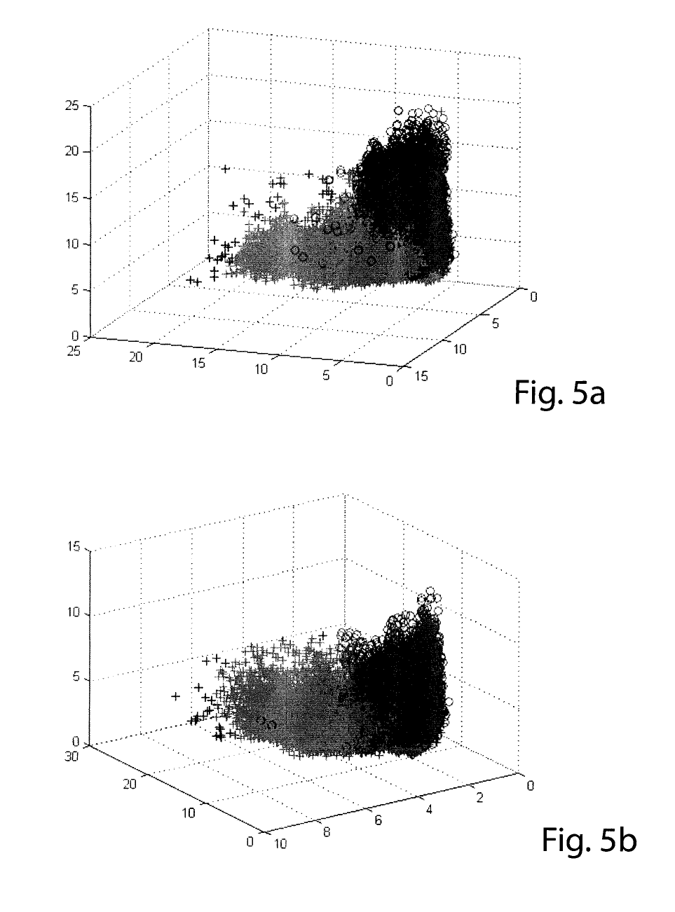

FIG. 5 shows the point clouds of the single touch and two touch points on x- and y-axis respectively. For visualization purpose, only a 3-D feature was used.

A Gaussian density classifier is proposed here. Suppose samples of each group are from a multivariate Gaussian density N(μₖ,Σₖ), k=1, 2. Let xᵢ^{k}εR^{d} be the i-th sample point for the k-th group, i=1, . . . , Nₖ. For each group, the Maximum Likelihood (ML) estimation of the mean μₖ and covariance matrix σₖ is

$${μ}_{k} = \frac{1}{{N}_{k}} {\sum }_{i} {x}_{i}^{k} , {\sum }_{k} = \frac{1}{{N}_{k}} {\sum }_{k} ( {x}_{i}^{k} - {μ}_{k} ) {( {x}_{i}^{k} - {μ}_{k} )}^{T} .$$

With this estimation, the boundary is then defined as the equal Probabilistic Density Function (PDF) curve, and is given by

x^{T}Qx+Lx+K=0,

where Q=Σ₁⁻¹−Σ₂⁻¹, L=−2(μ₁Σ₁⁻¹−μ₂Σ₂⁻¹), and K=μ₁^{T}Σ₁⁻¹μ₁−μ₂^{T}Σ₂⁻¹μ₂−log |Σ₁|+log |Σ₂.

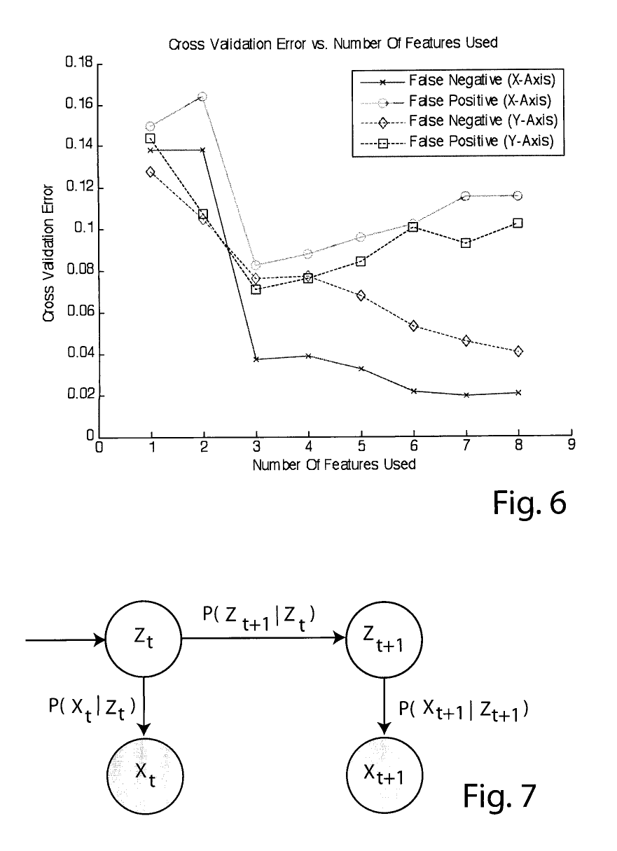

The features we propose to use are the statistics of the capacitance readings, which are the mean, the standard deviation and the normalized higher order central moments. For feature selection, we use k-fold cross validation on the training dataset with features up to the 8^{th} normalized central moment. The estimated false positive and false negative rates are shown in FIG. 6 It can be clearly seen that the best choice for the number of features is three, which are the mean, the standard deviation, and the skewness.

### Simplified Hidden Markov Model

To assess the classification results over time, we employ a simplified Hidden Markov Model (HMM) to implement a model-based probabilistic analyzer 26. The HMM exhibits the ability to smooth the detection over time in a probabilistic sense. In this regard, the output of the touch point classifier 24 can be though of as a sequence of time-based classification decisions. The HMM 26 analyzes the sequence of data from the classifier 24, to determine how those classification decisions may best be connected to define a smooth sequence corresponding to the gestural motion. In this regard, it should be recognized that not all detected points necessarily correspond to the same gestural motion. Two simultaneously detected points could correspond to different gestural motions that happen to be ongoing at the same time, for example.

The structure of the HMM we are using is shown in FIG. 7, where Xₜε{1,2} is the observation which is the classification results, and Zₜε{1,2} is the hidden state. Here we assume a homogeneous HMM, namely:

P(Zₜ_{₁}₊₁|Zₜ_{₁})=P(Zₜ_{₂}₊₁|Zₜ_{₂}),∀t₁,t₂, and

P(Σ_{t+δ}|Z_{t+δ})=P(Xₜ|Zₜ),∀δεZ⁺.

Without any prior knowledge, it is reasonable to assume Z₀˜Benoulli (p=0.5). Suppose at t, we have a prior knowledge about Zₜ₋₁, i.e. P(Zₜ₋₁|Xₜ₋₁, . . . , X₀), and the classifier gives the result Xₜ, the hidden state is then updated by the Bayesian rule

$$P ( {Z}_{t} \vert {X}_{t} , … {X}_{0} ) = \frac{\begin{matrix}{\sum }_{{Z}_{t - 1}} P ( {X}_{t} \vert {Z}_{t} ) P ( {Z}_{t} \vert {Z}_{t - 1} ) \\ P ( {Z}_{t - 1} \vert {X}_{t - 1} , … , {X}_{0} )\end{matrix}}{\begin{matrix}{\sum }_{{Z}_{t}} {\sum }_{{Z}_{t - 1}} P ( {X}_{t} \vert {Z}_{t} ) P ( {Z}_{t} \vert {Z}_{t - 1} ) \\ P ( {Z}_{t - 1} \vert {X}_{t - 1} , … , {X}_{0} )\end{matrix}}$$

Instead of maximizing the joint likelihood to find the best sequence, we made decision based on the posteriori P(Zₜ|Xₜ, . . . X₀). Once the posteriori is higher than a predefined threshold, which we set it very high, the state is confirmed and the number of touch points Nₜ were then passed to the peak detector to find the positions of the touch points.

### Peak Detector

From the confirmed number of touch points Nₜ, the peak detector found the first Nₜ largest local maxima. If there is only one touch point, the searching is straightforward as we only need to find the global maximum. Otherwise, when there are two touch points, after we found the two local maxima, we applied a ratio test, i.e. when the ratio of the value of the two peaks are very large, the lower one is deemed as a noise, and the two touch points coincide with each other on that dimension.

To achieve a subpixel accuracy, for each local maximum pair (xₘ, f(xₘ)), where xₘ is the position and f(xₘ) is the capacitance value, together with one point on either side, (xₘ₋₁, f(xₘ₋₁)) and (xₘ₊₁, f(xₘ₊₁)), we fit a parabola f(x)=ax²+bx+c. This is equivalent to solving a linear system

$$( \begin{matrix}{x}_{m + 1}^{2} & {x}_{m + 1} & 1 \\ {x}_{m}^{2} & {x}_{m} & 1 \\ {x}_{m - 1}^{2} & {x}_{m - 1} & 1\end{matrix} ) ( \begin{matrix}a \\ b \\ c\end{matrix} ) = ( \begin{matrix}f ( {x}_{m + 1} ) \\ f ( {x}_{m} ) \\ f ( {x}_{m - 1} )\end{matrix} ) .$$

Then the maximum point is refined to

$${x}_{m} = - \frac{b}{2 a} .$$

### Kalman Tracker

As the two dimensions of the capacitive sensor are independent, positions on x- and y-axis should be associated together to determine the touch point in the 2-D plane. When there are two peaks on each dimension (x₁, x₂) and (y₁, y₂), there could be two pair of possible associations (x₁, y₁), (x₂, y₂) and (x₁, y₂), (x₂, y₁), which have equal probability. This poses an ambiguity if at the very beginning there are two touch points. Hence, in the system, it is restricted to start from a single touch point.

To associate touch points at different time frames as well as smooth the movement, we employ a Kalman filter with a constant speed model. The Kalman filter evaluates the trajectory of touch point movement, to determine which x-axis and y-axis data should be associated as ordered pairs (representing a touch point).

Let us define z̅=(x, y, Δx, Δy) to be the state vector, where (x, y) are the position on the touch screen, (Δx, Δy) are the change in position between adjacent frames, and x̅=(x′, y′) is the measurement vector which is the estimation of the position from the peak detector.

The transition of the Kalman filter satisfies

z̅ₜ₊₁=H z̅ₜ+w

x̅ₜ₊₁=M z̅ₜ₊₁+u

where in our problem,

$$H = ( \begin{matrix}1 & 0 & 1 & 0 \\ 0 & 1 & 0 & 1 \\ 1 & 0 & 0 & 0 \\ 0 & 1 & 0 & 0\end{matrix} ) , and M = ( \begin{matrix}1 & 0 & 0 & 0 \\ 0 & 1 & 0 & 0\end{matrix} )$$

are the transition and measurement matrix, w˜N(0, R) and ν˜N(0, Q) are white Gaussian noises with covariance matrices R and Q.

Given prior information from past observations z̅˜N(μₜ, Σ), the update once the measure is available is given by

z̅ₜ^{post}=μₜ+ΣM^{T}(MΣM^{T}+R)⁻¹( x̅ₜ−Mμₜ)

Σ^{post}=Σ−M^{T}(MΣM^{T}+R)⁻¹M

μₜ₊₁=H z̅ₜ^{post}

Σ=HΣ^{post}H^{T}+Q

where z̅ₜ^{post} is the correction when the measurement x̅ₜ, is given, μₜ is the prediction from previous time frame. When a prediction from previous time frame is made, the nearest touch point in the current time frame is found in term of Euclidean distance, and is taken as the measurement to update the Kalman filter to find the correction as the position of the touch point. If the nearest point is outside a predefined threshold, we deem this as a measurement not found. The prediction is then shown as the position in the current time frame. Throughout the process, we keep a confidence level for each point. If a measurement is found, the confidence level is increased, otherwise it is decreased. Once the confidence level is low enough, the record of the point is deleted and the touch point is deemed as having disappeared.

From the foregoing it will be seen that the technology described here will enable multi-touch interaction for many audio/video products. Because the capacitive sensors can be packaged in a thin foil it can be used to produce very thin multi-touch displays at a very small additional cost.

1. A system for grab and drop gesture recognition, comprising:
a sensor array that provides gestural detection information that expresses touch point position information;
a gesture recognizer that analyzes the touch point position information using a trained model that discriminates between grab gestures and touch gestures, the gesture recognizer providing an indication of a grab gesture occurrence;
a drop detector configured to monitor gestural detection information in response to recognition by said gesture recognizer of a grab gesture occurrence, the drop detector providing an indication that a drop gesture has occurred in association with said grab gesture occurrence.

2. The system of claim 1 wherein said sensor array provides independent X and Y coordinate values expressing said touch point position information.

3. The system of claim 1 wherein said sensor array is a capacitive sensor array.

4. The system of claim 1 wherein said gesture recognizer employs a Gaussian density classifier.

5. The system of claim 1 wherein said gesture recognizer employs a trained model based on a plurality of statistical features.

6. The system of claim 5 wherein the statistical features are selected from the group consisting of the mean, standard deviation, and the normalized higher order central moments.

7. The system of claim 1 wherein said drop detector ascertains that a drop gesture has occurred by comparing gestural detection information to a predetermined threshold.

8. The system of claim 7 wherein said predetermined threshold corresponds to a weighted average of the maximum and average values of the gestural detection information.

9. The system of claim 1 wherein said gestural detection information is based on capacitance data obtained from the sensor array.

10. A system for touch point gestural analysis, comprising:
a sensor array that provides gestural detection information that expresses touch point position information;
a touch point classifier configured to discriminate between a single touch gesture and a multiple touch gesture, the touch point classifier providing a sequence of classification decisions; and
a model-based probabilistic analyzer, receptive of the sequence of classification decisions, and operative to associate the classification decisions to at least one gestural motion.

11. The system of claim 10 wherein said sensor array provides independent X and Y coordinate values expressing said touch point position information.

12. The system of claim 10 wherein said sensor array is a capacitive sensor array.

13. The system of claim 10 wherein said touch point classifier employs a Gaussian density classifier.

14. The system of claim 10 wherein said touch point classifier employs a trained model based on a plurality of statistical features.

15. The system of claim 14 wherein the statistical features are selected from the group consisting of the mean, standard deviation, and the normalized higher order central moments.

16. The system of claim 10 wherein the probabilistic analyzer employs a Hidden Markov Model.

17. The system of claim 10 further comprising a peak detector that refines the resolution of detected points associated with said at least one gestural motion by identifying maxima in said gestural detection information.

18. The system of claim 10 wherein said sensor array provides independent X and Y coordinate values expressing said touch point position information and further comprising Kalman tracker to resolve ambiguity as to how to associate given X and Y coordinate values into ordered pairs.

19. The system of claim 18 wherein said Kalman tracker evaluates the trajectory of touch point movement and associates given X and Y coordinate values that are most consistent with the observed movement.

20. A method of detecting a grab gesture comprising:
obtaining data from a sensor array that provides gestural detection information that expresses touch point position information;
analyzing the touch point position information using a trained model that discriminates between grab gestures and touch gestures;
using the results of said analyzing step to provide an indication that a grab gesture has occurred.

21. A method of detecting a grab and drop gesture comprising:
obtaining data from a sensor array that provides gestural detection information that expresses touch point position information;
analyzing the touch point position information using a trained model that discriminates between grab gestures and touch gestures and providing an indication of grab gesture occurrence;
monitoring said gestural detection information in response to said grab gesture occurrence to detect that a drop gesture has occurred and providing a corresponding indication of a drop gesture occurrence;
associating said grab gesture occurrence with said drop gesture occurrence.

22. A method of analyzing a touch gesture comprising:
obtaining data from a sensor array that provides gestural detection information that expresses of touch point position information;
classifying said gestural detection information according to whether it expresses a single touch gesture or a multiple touch gesture and providing a sequence of classification decisions; and
analyzing the classification decisions using a model-based probabilistic analyzer to associate the classification decisions to at least one gestural motion;

23. The method of claim 22 further comprising identifying maxima in said gestural detection information to refine the resolution of detected points associated with said at least one gestural motion.

24. The method of claim 22 further comprising developing independent X and Y coordinate values from said gestural detection information and associating given X and Y coordinate values into ordered pairs.

25. The method of claim 24 wherein said associating given X and Y coordinate values into ordered pairs using a Kalman filter.
